(19) United States
(12) Patent Application Publication
(10) Pub. No.: US 2003/0020809 A1
(43) Pub. Date: Jan. 30, 2003

(54) Methods and apparatuses for superimposition of images

(76) Inventors: Michael A Gibbon, Oakville (CA); Steven Read, Mississauga (CA); Samuel Z Zhou, NorthYork (CA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/220,575

(22) PCT Filed: Mar. 12, 2001
(86) PCT No.: PCT/IB01/00347

(51) Int. Cl. H04N 15/00; H04N 13/04

(52) U.S. Cl. 348/51

(57) ABSTRACT

In one embodiment of this invention, two sub-images for superimposition are created using a single spatial light modulator. A first sub-image is projected with the SLM at a first position and, during the same frame, a second sub-image is projected using the same SLM at a second position. In another embodiment, high resolution, stereoscopic images are created using the principle of temporal superimposition and an electronic projection system having a minimum of low resolution SLMs. The invention alternately projects off-set image sub-fields to cach eye, which are then combined by the human visual system into a single, integrated high resolution image. The human visual system similarly integrates the separate left and right eye images into a single, three dimensional image.

### FIELD OF THE INVENTION

The field of the invention is image projection in general, and electronic image projection in particular.

### BACKGROUND OF THE INVENTION

U.S. Pat. No. 5,386,253 to Fielding, incorporated herein in its entirety by this reference, discusses exemplary projection systems utilizing one or more spatial light modulators (SLMs). As noted in the Fielding patent:

Spatial light modulator devices include so-called “active matrix” devices, comprising an array of light modulating elements, or “light valves,” each of which is controllable by a control signal (usually an electrical signal) to controllably reflect or transmit light in accordance with the control signal. A liquid crystal array is one example of an active matrix device; another example is the deformable mirror device (DMD) developed by Texas Instruments . . . .

See Fielding, col. 1, 11. 13-21. Of course, yet other types of light “engines,” or sources, and projectors exist, and various of them may be used in connection with the inventions described herein.

Regardless of the type of projector used, audiences frequently desire to see images high in detail and richness and low in objectionable artifacts. High resolution and image quality in particular facilitates suspension of disbelief of an audience as to the reality of the projected images. Such quality indeed often is an important factor in the overall success of the motion picture viewing experience among today's audiences.

Providing high resolution images to audiences can be prohibitively expensive in terms of producing the software, and in terms of the hardware necessary to show high resolution images. Imax Corporation, for example, the intended assignee of this application, utilizes not only specialized cameras and projectors, but also seventy millimeter, fifteen perforation film to increase the resolution and quality of projected images.

In some venues, it is desirable to be able to display high resolution moving picture images that are non-film based, such as computer generated graphics, or material captured with electronic cameras. It is particularly prohibitive to display these kinds of high resolution images using conventional electronic projectors (and especially those utilizing SLMs) because it is not technically or economically feasible to produce the necessary spatial light modulators (SLM) at sufficient resolution to match the high resolution of the source material. As well, such electronic projectors frequently fail to furnish the dynamic range and overall brightness of images provided by large-format films.

In one solution to achieve the desired resolution, conventional electronic projection systems have employed “tiling” techniques. Tiling involves the use of multiple projection displays of sub-images that are displayed adjacent to each other to form a composite image. The use of multiple projection displays allows for greater resolution than is available with a conventional single projection display. The sub-images can be blended inside a single projector or if multiple projectors are used, the sub-images are blended on the screen. For example, when two projectors are used one projector projects a first sub-image on a screen. A second projector projects a second sub-image on a screen. The first and second projectors are positioned such that the first and second sub-images are projected onto a screen adjacent to each other.

It is difficult to align the projectors exactly and therefore undesirable seams between the first and second sub-images are often apparent to the viewer. To improve the appearance and continuity of the composite image, the first and second projectors are conventionally positioned such that the first image slightly overlaps the second image. Mere overlapping of sub-images typically is insufficient, however, as the additive intensity of the images in the regions of overlap in some scenes likewise may be noticeable to audiences. General methods of reducing brightness in these regions require careful matching of the displays at the seam area(s), both geometrically and photometrically.

Another approach is to combine or superimpose two or more sub-images by off-setting two or more SLMs by, for example, one half of a pixel. With this approach, the sub-images are simultaneously displayed and the pixels of one spatial light modulator are positioned to lie between the spaces of the pixels of another SLM. This approach is discussed in U.S. Pat. No. 5,490,009. A disadvantage of this approach is that it requires twice the number of SLM devices while the resulting combined resolution of the two SLMs is limited to being less than a factor of two horizontally or vertically. This is because there is always some overlapping of superimposed pixels since for reasons of uniformity and efficiency it is desirable that the pixels be as nearly equal to 100% of the space allowed by their pitch as possible. This effectively limits the gain in resolution to about the square root of two horizontally or vertically, which produces an overall increase in the number of pixels of about 1.4 times.

There are also times when it is desired to produce stereoscopic or three dimensional (3D) images with an electronic projector. Typically the projection of stereoscopic or 3D images requires two separate image projectors, one dedicated to projecting left eye images, and the other dedicated to projecting right eye images. This requirement when combined with a superimposition technique that doubles the number of required SLMs in order to produce the necessary high resolution can be cost prohibitive.

### SUMMARY OF THE INVENTION

In one embodiment of this invention, two sub-images for superimposition are created using a single spatial light modulator. A first sub-image is projected with the SLM at a first position and, during the same frame, a second sub-image is projected using the same SLM. in one embodiment, micro-actuators are used to move the SLM from the first to the second position. The SLM is subsequently moved back to the first position for the projection of the next image frame. The first and second position of the SLM are such that the two resulting sub-images are offset by one half of a pixel in both horizontal and vertical directions, allowing the two sub-images to combine to produce a final image having a greater resolution than that provided by the actual pixels contained in the SLM.

The first and second projection positions may be discreet static positions, or they may bc continuously varying dynamic positions, such as the crest and trough portions of a sinusoidal motion profile.

In another embodiment, high resolution, stereoscopic images are created using the principle of temporal superimposition and an electronic projection system having a minimum of low resolution SLMs. The invention alternately projects off-set image sub-fields to each eye, which are then combined by the human visual system into a single, integrated high resolution image. The human visual system similarly integrates the separate left and right eye images into a single, 3D image.

### BRIEF DESCRIPTION OF THE DRAWINGS

FIGS. 1 to 3 are schematic block diagrams illustrating the general structure of an active matrix projection system.

FIG. 4 is an illustration of a spatial light modulator in accordance with the invention at a first display position.

FIG. 5 is an illustration of the spatial light modulator in accordance with the invention at a second display position.

FIG. 6 is a close up of the pixels of a spatial light modulator illustrating the superimposition of pixels to create a higher effective resolution.

FIG. 7 is a schematic illustrating the means by which a SLM may be moved from one position to another in accordance with the invention.

FIGS. 8 and 9 illustrate two motion profiles of the SLM.

FIGS. 10 and 11 illustrate two path profiles of the SLM.

FIG. 12 is a schematic of the arrangement of spatial light modulators and optics of the inventive method and apparatus.

FIG. 13 is a timing diagram of the sub-images projected by the novel projector.

FIG. 14 is a timing diagram of the state of polarization of each of the lenses in the pair of electronic glasses.

FIG. 15 is a timing diagram of the sub-images projected by the projector in an alternate embodiment.

FIG. 16 is a timing diagram of the alternate eye glasses associated with the alternate embodiment depicted in FIG. 15.

FIG. 17 is a schematic of an embodiment of a projector incorporating an electrically controllable wave plate.

FIG. 18 is a diagram of the polarization of light produced by the projector of FIG. 17.

FIG. 19 is a timing diagram of the sub-images projected by the projector of FIG. 17.

### DETAILED DESCRIPTION

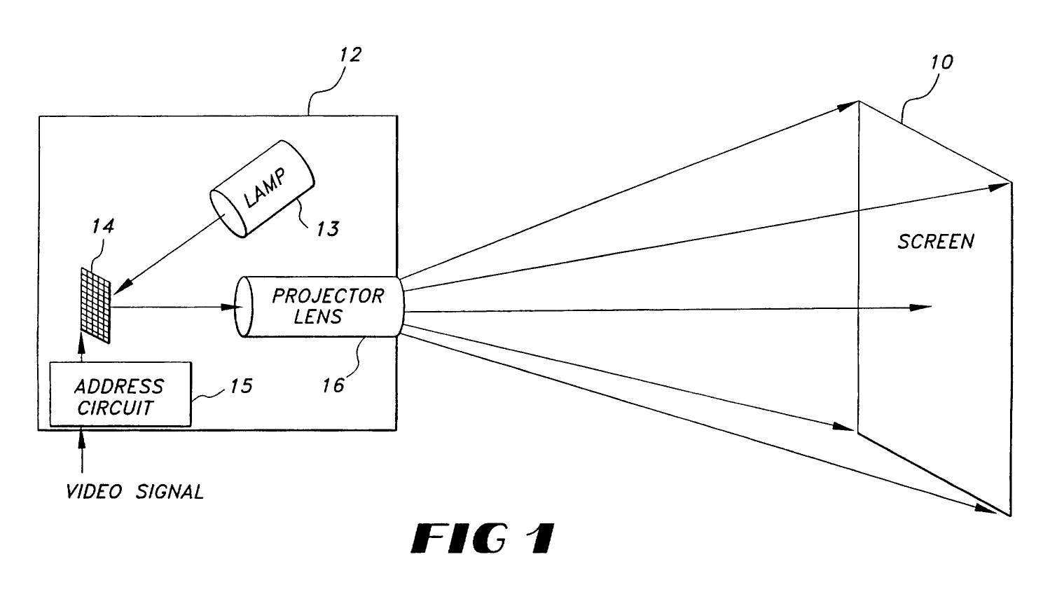

Referring to FIG. 1, a projection system comprises a reflective screen (for example a cinema screen) 10 and a projector 12, positioned and aligned relative to the screen so as to generate a focused image on the screen 10.

The projector 12 comprises a lamp 13, typically rated at several kilowatts for a cinema application, generating a light beam which is directed onto a planar active matrix display device 14 comprising, for example, a DMD array of 512×512 individual pixel mirrors. Each mirror of the display device 14 is individually connected to be addressed by an addressing circuit 15 which receives a video signal in any convenient format (for example, a serial raster scanned interlaced field format) and controls each individual mirror in accordance with a corresponding pixel value within the video signal. The reflected and modulated beam from the active matrix device 14 (or rather, from those pixels of the device which have been selectively activated) is directed to a projector lens system 16 which, in a conventional manner, focuses, magnifies and directs the beam onto the screen 10 as shown schematically in FIG. 2.

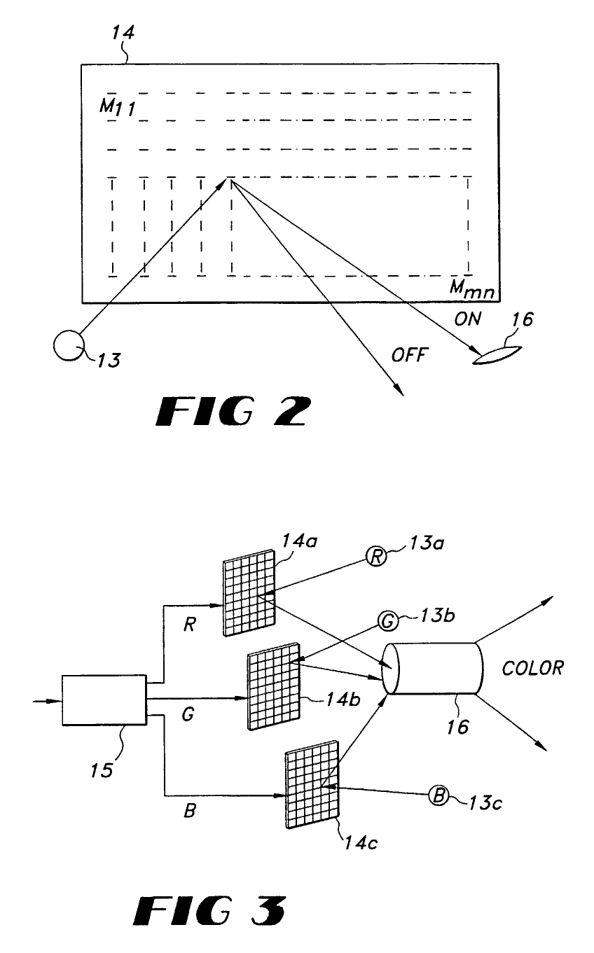

For a color system, three separate active matrixes as shown in FIG. 3 or three separate lamps with one SLM and a combining prism can be used. Other color systems are also known.

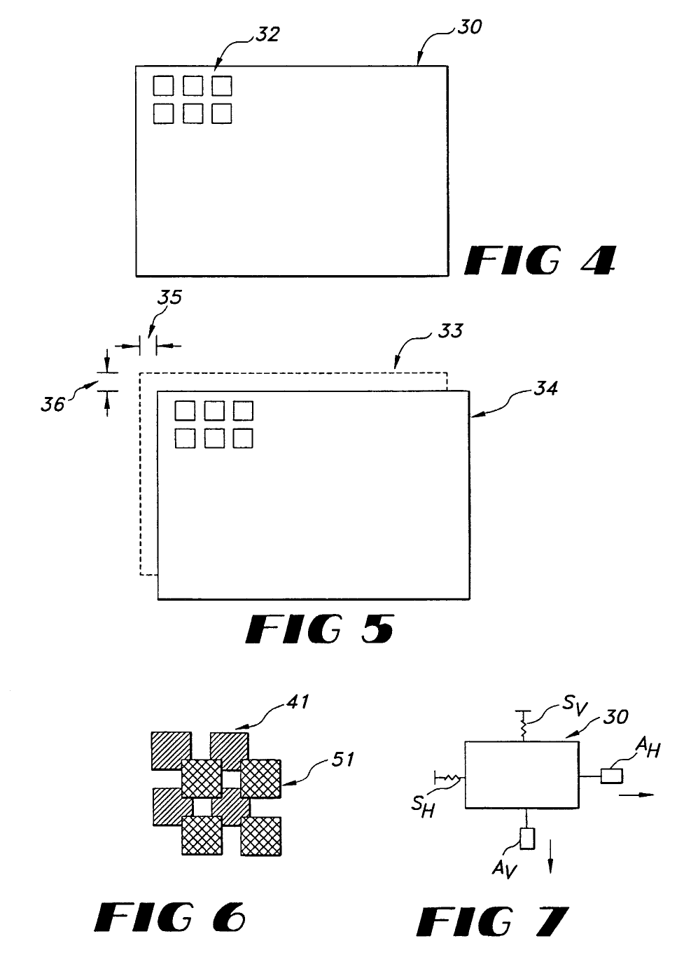

Referring now to FIG. 4, there is illustrated a spatial light modulator (SLM) 30 having a plurality of pixels 32 arranged in a grid of rows and columns. SLM 30 could be a deformable mirror device, (DMD) such as that sold by Texas Instruments, in which each of the pixels is actually micro-steerable mirrors which can be toggled between an off-state and an on-state in rapid succession, as is necessary to display an image onto a projection screen. The total number of pixels in a DMD device is typically limited by technological and economic factors, and commercially available DMD chips are not capable of projecting very high resolution images such as those that are associated with 70 mm motion picture film.

In one embodiment of this invention, a single SLM is used to project two sub-images during a single frame where the sub-images are offset by a some portion of a pixel. FIG. 5 shows SLM 30 in the two projection positions. Position 33 is indicated by ghost outline, whereas position 34 is indicated by the solid black lines. Position 34 is an offset of position 33 by, for example, slightly less than one pixel horizontally 35 and vertically 36.

FIG. 6 is a close up of pixels in the two positions illustrating how the pixels at the second position are positioned to be in the spaces between the pixels at the first position. The dark pixels, 51 are indicative of the pixels at the second position, whereas the lighter cross-hatched pixels 41 are indicative of the pixels at the first position. The two sub-images created by projection images at the two different positions, even though displaced in time, are combined by the human visual system into a single coherent image, in a manner similar to that in which separate images, projected rapidly are perceived as a smoothly moving image.

In FIG. 7, a SLM 30 is schematically shown to be connected with two linear actuators, A_{H} and Aᵥ and to two springs, S_{H} and S_{V}. The springs, S_{H} and S_{V}, act to bias SLM 30 in position 33—S_{H} in the horizontal direction and S_{V} in the vertical direction. Actuator A_{H} acts to move SLM 30 in the horizontal direction and actuator A_{V} acts to move SLM 30 in the vertical direction. Actuators A_{H} and A_{V} act together to move SLM 30 from position 33 to position 34. Actuators A_{H} and A_{V} may be piezoelectric actuators, such as those supplied by Physik Instrumente GmbH of Germany, which are capable of precise positioning down to the subnanometer range.

This example is illustrative only, and other means know to those skilled in the art may be used to move the SLM from a first position to a second position. Additionally, the sub-images could be generated by moving other components within the projection system, other than the SLM. For example, a mirror or a group of optical elements such as a 1:1 relay carrying the image from the SLM within the projector could be moved between two positions thereby creating two complementary sub-images when projected onto the screen.

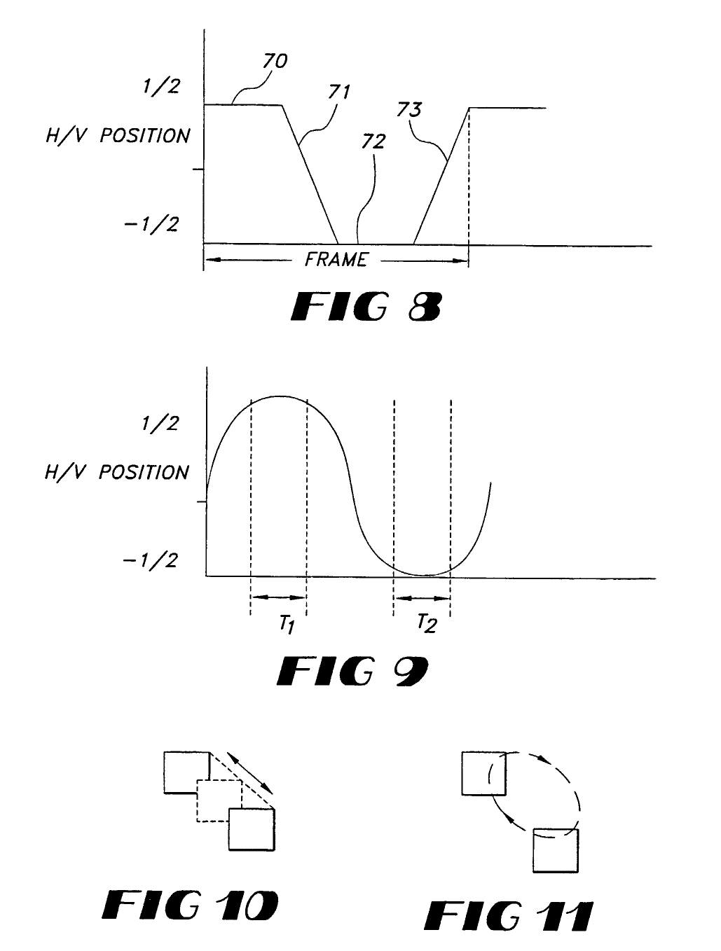

In FIG. 8 a timing diagram is shown illustrating linear motion of a SLM 30 from a first position indicated by 70 to a second position indicated by 72. At 70 and 72 the SLM 30 is stationary for the duration of the sub-frame projection period. The periods 71 and 73, represent the time required for the SLM 30 to travel from the first position to the second position, and back again. The sum of the periods 70 to 73 is equivalent to one normal frame in motion picture projection—typically 1/24 of a second or approximately 41 milliseconds. A projector incorporating the inventive method should be capable of displaying images at twice the normal frequency, or frame rate.

In FIG. 9 a timing diagram is shown illustrating a sinusoidal motion profile in which the SLM 30 never comes to a discreet stop, but is in continuous motion from one position to the other. The motion profiles are designed so as to maximize the time when the SLM is essentially stationary (T1 and T2 in the diagram) without requiring the mechanical system to bring it to a complete stop.

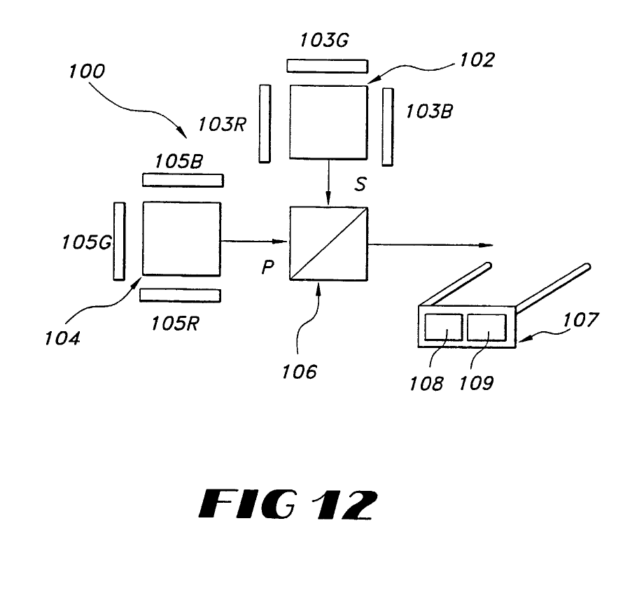

FIGS. 10 and 11 illustrate two possible motion paths for moving the SLM from one position to the other. In FIG. 10 a single pixel is shown in each of the two extreme positions and a linear path of motion for the pixel is shown. A linear path is produced, for example, by the actuators, A_{H} and A_{V}, in FIG. 7 moving in the respective directions at the same time and at the same rate. FIG. 11 illustrates an elliptical path of motion, which may be desirable for reasons of mechanical durability. This elliptical path is produced, for example, by the actuators, A_{H} and A_{V}. in FIG. 7 moving in their respective directions at varying rates and times.

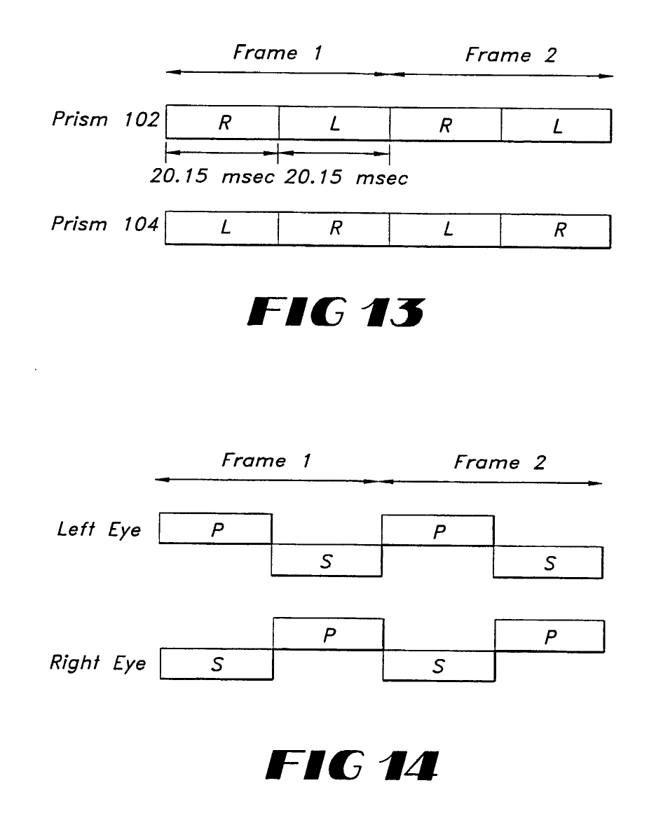

Referring now to an alternative embodiment illustrated in FIG. 12, a projector 100 is depicted schematically and is comprised of six separate SLMs, grouped in two sets of three, each group having its own combining prism. Prism 102 has separate red 103R, green 103G and blue 103B SLMs. Prism 102 combines the light of each of the three separate SLMs into one full color light beam, which exits in the direction indicated by arrow S. Similarly, prism 104 has separate red 105R, green 105G, and blue 105B SLMs. Prism 104 combines the light of each of the three separate SLMs, which exits in the direction indicated by arrow P.

The light from both prisms 102 and 104 is directed towards a polarizing beam splitter, 106, as seen in FIG. 12. The light from prism 102 becomes linearly polarized in an “s” orientation, and the light from prism 104 becomes linearly polarized in an orthogonal, or “p” orientation.

Prisms 102 and 104 are offset slightly in relation to each other, so that images formed by each can be superimposed on the screen thereby creating composite images that have a higher overall resolution than one generated by either prism alone. Typically, the prisms and/or SLMs are oriented so that the output of one prism is offset by one half of a pixel vertically, horizontally or both.

Electronic glasses, 107, as seen in FIG. 12, are provided to audience members in order to decode the spatial and temporal multiplexing of the images as produced by the projector.

The glasses have liquid crystal lenses, 108 and 109, which can be alternately switched between two orthogonal states of polarization. Such liquid crystal lenses are similar to those used in alternate eye 3D electronic glasses, such as those used by Imax Corporation, except they lack a front polarizer, which is commonly included with liquid crystals to enable them to operate as alternately transmissive and opaque shutters.

A timing diagram is depicted in FIG. 13, which shows the sequencing of images produced by the two separate prisms within projector 100. Referring now to the output of prism 102, a first right (R) eye sub-field is projected onto the screen during the first portion of frame I. The duration of one frame is typically 1/24 second (or 40.3 milliseconds). The output of prism 102 is then switched to provide a sub-frame intended for the left (L) eye. Similarly, the output of prism 104 alternates between a first left (L) eye sub-field, followed by a right (R) eye sub-field. The polarization of the images from prism 102 is “s” and the polarization of the images from prism 104 is “p”.

FIG. 14 depicts a timing diagram which indicates the state of polarization of the lenses in the glasses worn by viewers. During the first half of a frame period, the left eye lens transmits the light produced by prism 104, and blocks the light produced by prism 102. As shown in FIG. 14, this is accomplished by setting the polarity on the left eye lens to “p”. Thus, letting in all the light polarized in the p direction and keeping out all of the light polarized in the s direction. In the second half of the frame period, after the polarization of the left lens has been switched, it transmits the light produced by prism 102, and blocks the light produced by prism 104. Similarly, this is accomplished by changing the polarity on the left eye lens to “s”. Thereby, the left eye lens lets in all the light polarized in the s direction and blocks light polarized in the p direction during the second half of the frame. As can be seen in FIG. 14, the right eye lens in the glasses is operated out of phase with the left eye lens—letting in light polarized in the s direction during the first half of the frame and letting in light polarized in the p direction during the second half of the frame. The operation of the lens allows each eye to see the images intended only for it, thus allowing the human visual system to integrate the two sets of images into a three dimensional image.

Since the light output by prisms 102 and 104 are offset relatively, the composite image can be temporally fused by the human visual system, resulting in the perception of a higher resolution image than the images produced by either prism alone. Experiments have shown that temporal fusing can occur if the switching between sub-images is fast enough. Typically the overall resolution can be improved by a factor of about 1.4.

In another embodiment, the timing profile is changed so that the frequency of subframes is increased, for example by a factor of two, so that each sub-frame is displayed for a period of about 10 msec.

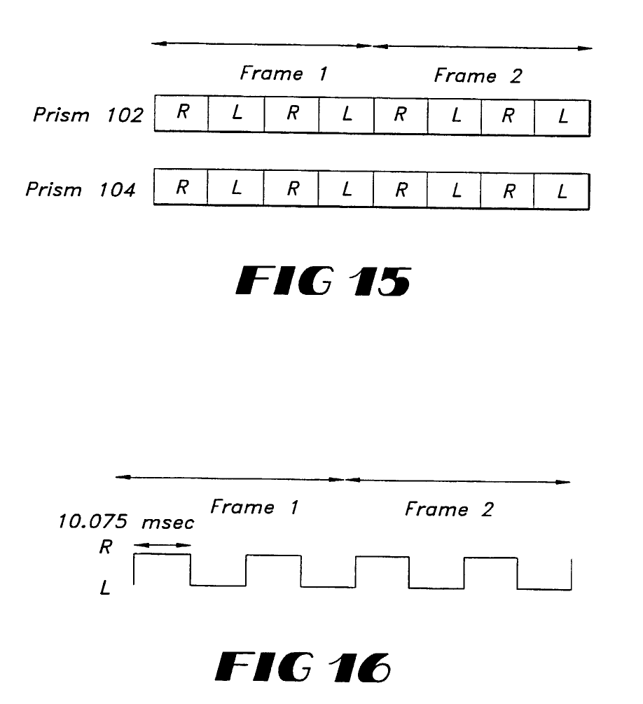

In yet another embodiment, the offset sub-fields are presented simultaneously to one eye, while the other eye is blocked by an opaque shutter. Here the polarizing beam splitter is replaced by an alternative method that does not rely on polarization to combine the two images. The eyeglasses act to direct the light from both sub-fields to the appropriate eye. In the subsequent time period, the first eye is blocked by a shutter, and the other eye is presented with two offset sub-fields simultaneously. The eyeglasses required by this embodiment are standard alternate-eye electronic liquid crystal shutter glasses. This embodiment is illustrated in FIGS. 15 and 16.

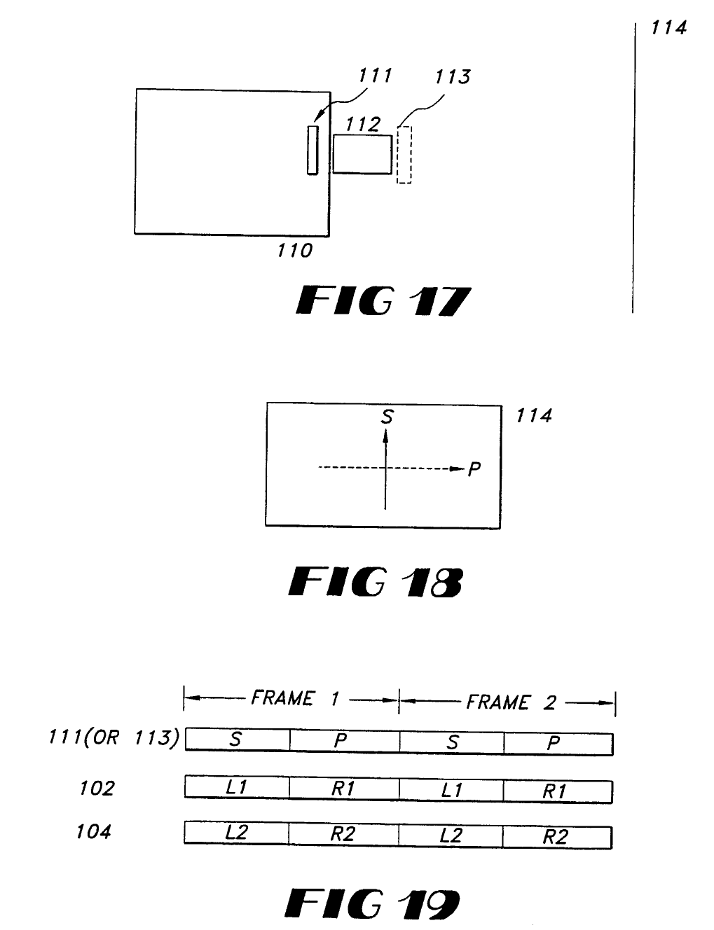

In an alternative embodiment, viewers wear passive glasses in which the lenses are mutually orthogonal linear polarizers. An active alternate phase ¼ wave plate (such as a Ferroelectric Liquid Crystal) is located at the projector and switches the polarization of the light by 90 degrees every half frame (approximately 20 msec.) FIG. 17 depicts a projector 110 with lens 112 incorporating an electrically controllable wave plate 111 located prior to the lens. The wave plate could alternatively be located after the lens as illustrated by the dashed lines 113. This projector produces the two overlapped images from prisms 102 and 104 (not shown in FIG. 17, but shown in FIG. 12) onto screen 114. FIG. 18 illustrates how the switching of the polarization of 111 (or 113) causes the light that reaches the screen 114 to alternate in polarity, corresponding alternately to the images from prisms 102 and 104.

FIG. 19 illustrates the switching arrangement for the sub-images presented to prisms 102 and 104, and the switching of the polarity of 111 (or 113). The controllable wave plate 111 (or 113) switches at two times the frame rate (approximately 20 msec. for 24 frames per second) and prisms 102 and 104 carry the appropriate eye sub-image at each time.

In all cases it should be noted that the while a frame rate of 24 fps is typical for motion picture films, other frame rates are commonly employed and may be used without departing from the spirit of the invention. It should also be noted that visual fusion of the sub-images is improved by higher frame rates, and this will contribute to an improvement in the quality of the results obtained from the temporal superimposition.

The foregoing is provided for purposes of explanation and disclosure of preferred embodiments of the present invention. For instance, a preferred embodiment of this invention involves using a deformable mirror device as the spatial light modulator. It is expected that such capabilities or their equivalent will be provided in other standard types of spatial light modulators, in which case the preferred embodiment of this invention may be easily adapted for use in such systems. Further modifications and adaptations to the described embodiments will be apparent to those skilled in the art and may be made without departing from the scope or spirit of the invention and the following claims.

What is claimed is:

1. A method of enhancing the resolution of a spatial light modulator (SLM)-based display system having optics, comprising:
(a) projecting a first sub-image using an SLM during a frame; and
(b) projecting a second sub-image offset from the first sub-image using the SLM during the frame.

2. The method of claim 1 wherein the first sub-image is offset from the second sub-image by less than one pixel.

3. The method claim 1 wherein the first sub-image is offset from the second sub-image by moving the optics in the projection system.

4. The method claim 1 wherein the first sub-image is offset from the second sub-image by moving the SLM from a first position to a second position.

5. The method of claim 4 wherein the SLM is biased in the first position by at least one spring and is moved from a first position to a second position by at least one actuator.

6. The method of claim 4 wherein the SLM moves from the first position to the second position in a linear motion.

7. The method of claim 4 wherein the SLM moves from the first position to the second position in a non-linear motion.

8. A method of enhancing the resolution of a spatial light modulator (SLM)-based display system, comprising:
(a) projecting a first sub-image using an SLM at a first position during a frame;
(b) moving the SLM from the first position to a second position during the frame; and
(c) projecting a second sub-image using the SLM at the second position during the frame, wherein the first and second sub-images are offset.

9. The method of claim 8 wherein the first sub-image is offset from the second sub-image by less than one pixel.

10. The method of claim 8 wherein the SLM is biased in the first position by at least one spring and is moved from a first position to a second position by at least one actuator.

11. The method of claim 8 wherein the SLM moves from the first position to the second position in a linear motion.

12. The method of claim 8 wherein the SLM moves from the first position to the second position in a non-linear motion.

13. A spatial light modulator (SLM)-based display system comprising:
a light source;
a spatial light modulator;
an addressing circuit electrically coupled to the spatial light modulator, wherein the addressing circuit controls the spatial light modulator;
at least one biasing spring connected to SLM for biasing SLM in a first position during a frame; and
at least one actuator connected to the SLM and electrically coupled to the addressing circuit, wherein the actuator receives signals from the addressing circuit to move the SLM to a second position during the frame.

14. The system of claim 13 wherein the SLM projects a first sub-image in the first position and projects a second sub-image in the second position, wherein the first sub-image is offset from the second sub-image.

15. The method of claim 14 wherein the first sub-image is offset from the second sub-image by less than one pixel.

16. A method of producing stereoscopic images in a spatial light modulator (SLM)-based system having a single projector, comprising:
(a) creating a first sub-image with at least a first SLM in the projector;
(b) creating a second sub-image with at least a second SLM in the projector;
(c) combining the first sub-image and the second sub-image; and
(d) projecting the combined first and second sub-images on a screen,
wherein the first and second sub-images are superimposed and the second sub-image is offset from the first sub-image on the screen.

17. The method of claim 16, wherein the first sub-image and the second sub-image are combined such that the first sub-image is linearly polarized in a fist orientation and the second sub-image is linearly polarized in a second orientation.

18. The method of claim 16 further comprising allowing only the sub-image intended for a viewer's first eye to be viewed by the first eye and allowing only the sub-image intended for a viewer's second eye to be viewed by the second eye.

19. The method of claim 17 further comprising setting the polarization in a right lens of a viewer's glasses to the first orientation and setting the polarization in a left lens of the viewer's glasses to the second orientation during a frame; and changing the polarization in the right lens to the second orientation and changing the polarization in the left lens to the first orientation during the frame.

20. The method of claim 16 further comprising allowing a viewer to see both sub-images with a first eye and blocking the view of the sub-images to a second eye during a frame; and allowing the viewer to see both images with the second eye and blocking the view of the sub-images to the first eye during the frame.

21. The method of claim 16 wherein each sub-image is displayed for half of a frame.

22. A method of producing stereoscopic images In a spatial light modulator (SLM)-based system having a single projector, comprising:
(a) creating a first sub-image with at least a first SLM in the projector;
(b) creating a second sub-image with at least a second SLM in the projector,
(c) combining the first sub-image and the second sub-image so that the first sub-image is in a first orientation and the second sub-image is in a second orientation;
(d) projecting the combined first and second sub-images on a screen, wherein the first and second sub-images are superimposed and the second sub-image is offset from the first sub-image on the screen; and
(e) switching the orientation of the sub-images at a predetermined time.

23. The method of claim 22 wherein the orientation of the sub-images is switched at two times the frame rate.

24. The method of claim 22 wherein the orientation of the sub-images is controlled by an electrically controllable wave plate.

25. A projector; comprising:
a light source for producing a light beam;
a first spatial light modulator (SLM) for producing a first sub-image from the light beam;
a second spatial light modulator (SLM) for producing a second sub-image from the light beam;
a combiner for combining the first sub-image and the second sub-image;
a projection lens for projecting the combined first sub-image and the second sub-image.

26. The projector of claim 25, wherein the first sub-image and the second sub-image are combined such that the first sub-image is linearly polarized in a first orientation and the second sub-image is linearly polarized in a second orientation.

27. The projector of claim 26 further comprising a pair of glasses, wherein polarization in a right lens of the glasses is set to the first orientation and polarization in a left lens of the glasses is set to the second orientation during a frame and the polarization in the right lens is changed to the second orientation and the polarization in the left lens is changed to the first orientation during the frame.

28. The projector of claim 25 further comprising a pair of glasses that allow a viewer to see both sub-images with a first eye and block the view of the sub-images to a second eye during a frame and allow the viewer to see both images with the second eye and block the view of the sub-images to the first eye during the frame.

29. The projector of claim 25 wherein each sub-image is displayed for half of a frame.
